(19) United States
(12) Patent Application Publication
(10) Pub. No.: US 2025/0212115 A1
(43) Pub. Date: Jun. 26, 2025

(54) SYSTEMS AND METHODS FOR ENERGY MANAGEMENT IN A BASE STATION ON A SERVICE BASIS

(71) Applicant: HFCL Limited, Bangalore (IN)

(72) Inventors: Subhas Chandra MONDAL, Karnataka (IN); Valluri Satyanarayana MURTHY, Karnataka (IN)

(21) Appl. No.: 19/001,127

(22) Filed: Dec. 24, 2024

(30) Foreign Application Priority Data
Dec. 26, 2023 (IN) 202341088857

(51) Int. Cl. H04W 52/02

(52) U.S. Cl. CPC H04W 52/0206

(57) ABSTRACT

Systems (200) and methods for energy management in a base station (1102) on a per service basis are described. In particular, the method includes receiving a request for a service corresponding to a user equipment in an access network (102), determining a type of the service based on the request, estimating a power consumption value for each phase of the service corresponding to the base station (1102), and transmitting the power consumption value to a core network (108). Further, the method includes receiving a power consumption policy associated with the type of the service from the core network (108), determining a real-time power consumption value of the service corresponding to the base station (1102), and monitoring the real-time power consumption value corresponding to the base station (1102) based on the power consumption policy.

### RELATED APPLICATION

This application claims priority from Indian Application No. 202341088857, filed Dec. 26, 2023, the subject matter of which are incorporated herein by reference in their entirety.

### TECHNICAL FIELD

The present disclosure, in general, relates to energy optimization in a wireless communication network, and in particular, relates to power consumption in a base station on a per service basis.

### BACKGROUND

Energy efficiency is a key parameter in 5G and upcoming 6G technologies. While there are available mechanisms on energy management at a network node or a device level, there is a need to have a system and a method for computing energy consumption on a per service basis. There is no known system or method for determining the energy consumption at the service level.

In a wireless network, the network and the user equipment together provide the network services like voice service and data service to the end user. Hence, the total energy consumption at a service level involves energy consumed at the network and energy consumed at the user equipment. A major part of the energy consumed at the network side is spent in radio transceiver subsystem.

The existing solutions fail to disclose an efficient mechanism for adaptive power consumption at each phase of a service. Thus, there is a need for an efficient and adaptive mechanism for energy optimization for a base station for providing a service to a user equipment.

### OBJECTS OF THE PRESENT DISCLOSURE

It is an object of the present disclosure to provide an efficient solution for adaptive energy consumption for a base station for providing a service to a user equipment.

It is an object of the present disclosure to provide an efficient solution for service-based optimization of base station.

It is an object of the present disclosure to provide efficient power saving mechanisms during different phases of a service.

### SUMMARY

In an aspect, the present disclosure relates to a method for managing power consumption in an access network, including receiving, by a processor associated with a base station, a request for a service corresponding to a user equipment in the access network, determining, by the processor, a type of the service based on the request, estimating, by the processor, a power consumption value for each phase of the service corresponding to the base station, transmitting, by the processor, at least the estimated power consumption value to a core network, receiving, by the processor, a power consumption policy associated with the type of the service from the core network, determining, by the processor, a real-time power consumption value of the service corresponding to the base station, and monitoring, by the processor, the real-time power consumption value corresponding to the base station based on the power consumption policy.

In an embodiment, the power consumption policy may include one or more pre-defined power threshold values associated with the type of the service.

In an embodiment, monitoring, by the processor, the real-time power consumption value may include comparing, by the processor, the real-time power consumption value of the service with the one or more pre-defined power threshold values, and determining, by the processor, whether the real-time power consumption value is within the one or more pre-defined power threshold values.

In an embodiment, in response to a determination that the real-time power consumption value is within the one or more pre-defined power threshold values, the method may include continuing, by the processor, to monitor the real-time power consumption for a pre-defined time interval.

In an embodiment, in response to a determination that the real-time power consumption value is not within the one or more pre-defined power threshold values, the method may include transmitting, by the processor, the real-time power consumption value of the service to the core network.

In an embodiment, in response to receiving, by the processor, the power consumption policy, the method may include comparing, by the processor, the estimated power consumption value with the one or more pre-defined power threshold values, and determining, by the processor, whether the estimated power consumption value is within the one or more pre-defined power threshold values.

In an embodiment, in response to a determination that the estimated power consumption value is within the one or more pre-defined power threshold values, the method may include transmitting, by the processor, a positive acknowledgement to the core network, and in response to a determination that the estimated power consumption value is not within the one or more-predefined power threshold values, the method may include transmitting, by the processor, a negative acknowledgement to the core network.

In an embodiment, the real-time power consumption value may be based on at least one of: a power consumed by the base station in transitioning the user equipment from an idle phase to an active phase, a power consumed for a setup phase of the service, a power consumed for an active phase of the service, and a power consumed for the service in transition from the active phase to a terminate phase of the service.

In an embodiment, the real-time power consumption value may be based on at least one of: a power consumed for exchange of messages from the core network to the access network, and a power consumed in the access network.

In an embodiment, the method may include storing, by the processor, the real-time power consumption value of said each phase of the service corresponding to the base station and the user equipment for different Resource Block (RB) allocations and different time stamps in a database associated with the base station.

In an embodiment, the estimated power consumption value may be based on transport block size and modulation coding scheme.

In an embodiment, the method may include classifying, by the processor, the user equipment based on Physical Resource Block (PRB) utilization for a particular slot duration required for the service, wherein the estimated power consumption value is based on the classification of the user equipment.

In an embodiment, the power consumption policy may be based at least on one of: the estimated power consumption value including total power required in setup phase for the service, total power required in active phase for the service, total power required in terminate phase for the service, Physical Resource Block (PRB) utilization, category of the base station, rated power of the base station, and power amplifier efficiency of the base station.

In an embodiment, the type of the service may be a voice service, and the method may include determining, by the processor, a user subscription level associated with the user equipment, and configuring, by the processor, a packetization period for the user equipment based on the user subscription level.

In another aspect, the present disclosure relates to a base station for managing power consumption in an access network, including a processor, and a memory operatively coupled with the processor, wherein the memory includes instructions which, when executed, cause the processor to receive a request for a service corresponding to a user equipment in the access network, determine a type of the service based on the request, estimate a power consumption value for each phase of the service corresponding to the base station, transmit at least the power consumption value to a core network, receive a power consumption policy associated with the type of the service from the core network, determine a real-time power consumption value of the service corresponding to the base station, and monitor the real-time power consumption value corresponding to the base station based on the power consumption policy.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an exemplary system architecture of a Radio Access Network (RAN) device for implementing the proposed mechanism, in accordance with an embodiment of the present disclosure.

FIG. 2 illustrates an exemplary system architecture of a monitoring unit, in accordance with an embodiment of the present disclosure.

FIG. 3 illustrates a flow chart of an exemplary method for managing power consumption in an access network, in accordance with an embodiment of the present disclosure.

FIGS. 4-6 illustrate exemplary flow diagrams for different phases of a service, in accordance with embodiments of the present disclosure.

FIG. 7 illustrates a transition diagram for lifecycle of a service corresponding to a base station and a user equipment, in accordance with an embodiment of the present disclosure.

FIG. 8 illustrates an exemplary flow diagram of exchange of control messages in UE initial attach phase, in accordance with an embodiment of the present disclosure.

FIGS. 9A-9D illustrate exemplary flow diagrams for exchange of control messages during different phases of a service, in accordance with embodiments of the present disclosure.

FIGS. 10A and 10B illustrate exemplary representations of power distribution, in accordance with embodiments of the present disclosure.

FIG. 11 illustrates an exemplary flow diagram for exchange of messages between a base station and a core network, in accordance with embodiments of the present disclosure.

FIG. 12 illustrates an exemplary flow diagram for exchanges of messages between a base station and a core network once the base station receives a power consumption policy, in accordance with embodiments of the present disclosure.

FIG. 13 illustrates an exemplary transition diagram for a service, in accordance with embodiments of the present disclosure.

FIG. 14 illustrates an exemplary computer system in which or with which embodiments of the present disclosure may be implemented.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

The present disclosure relates to computing energy at a radio transceiver subsystem at network side. A service includes multiple phases including inactive phase, setup phase, active phase, and termination phase.

As an example, a voice service either may be in inactive phase while the UE is in idle mode or switched-off mode. When the UE is switched on, UE is attached to the network by spending energy for exchanging control information. Once the UE is in attached state, the network provides voice services for both, network originated, or UE originated voice call request. There will be energy spent during the setup phase, active phase, and termination phase.

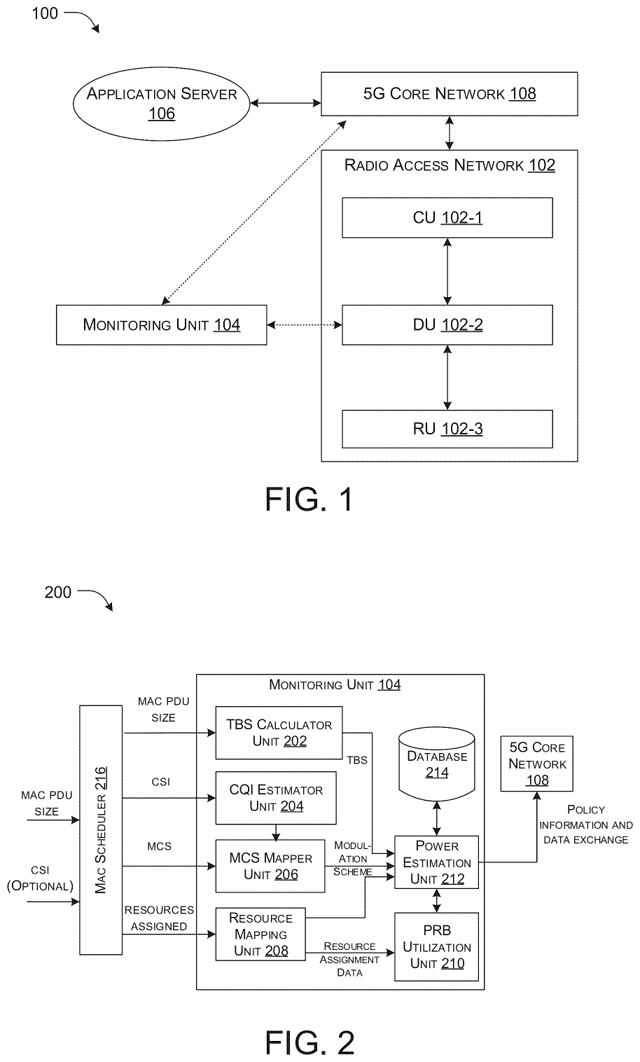

The various embodiments throughout the disclosure will be explained in more detail with reference to FIGS. 1-14.

FIG. 1 illustrates an exemplary system architecture 100 of a Radio Access Network (RAN) device for implementing the proposed mechanism, in accordance with an embodiment of the present disclosure.

In particular, FIG. 1 shows a high-level system architecture 100 of a RAN device 102 and its connection with 5G core network 108 in a disaggregated RAN architecture (as defined in Third Generation Partnership Project (3GPP) and O-RAN specifications). The application server 106 is the server, where application data may be present. 5G core network 108 maps the application layer data to the corresponding gNodeB (gNB) (i.e., access network). The Radio Resource Control (RRC) in the access network is performed in a Centralized Unit (CU) 102-1. The Radio Link Control (RLC) and Media Access Control (MAC) in the access network is performed in a Distributed Unit (DU) 102-2. Radio Unit (RU) 102-3 takes the input from the DU 102-2 and transmits a Radio Frequency (RF) signal over the air to a User Equipment (UE).

In some embodiments, communication between the application server 106 and the 5G core network 108 is performed using N6 interface. Similarly, communication between the 5G core network 108 and the RAN device 102 is performed using N3 interface.

In some embodiments, the monitoring unit 104 may be inside the DU 102-2. In some other embodiments, the monitoring unit 104 may be outside the DU 102-2. The monitoring unit 104 may calculate the total energy/power consumed by the gNB/base station on per service basis and may report the consumed power to upper layers, i.e., to the 5G core network 108 in case the monitoring unit 104 is inside the DU 102-2; and to the 5G core network 108 and the DU 102-2 in case the monitoring unit 104 is outside the DU 102-2. It may be appreciated that the monitoring unit 104 may be interchangeably referred to as the system herein. In some embodiments, the system may include a processor, and a memory operatively coupled with the processor. The memory may include processor-executable instructions which, when executed, cause the processor to perform the methods herein.

FIG. 2 illustrates an exemplary system architecture 200 of a monitoring unit 104, in accordance with an embodiment of the present disclosure.

Referring to FIG. 2, the monitoring unit 104 may be used to estimate and monitor power consumption for a particular service in real-time. Additionally, the monitoring unit 104 may also estimate the power consumption by a base station per service including all phases of the service. The monitoring unit 104 includes a Transport Block Size (TBS) calculator unit 202, a Channel Quality Indicator (CQI) estimator unit 204, a Modulation Coding Scheme (MCS) mapper unit 206, a resource mapping unit 208, a Physical Resource Block (PRB) utilization unit 210, a power estimation unit 212, and a database 214. It may be appreciated that there may be more or fewer number of components in the monitoring unit 104 within the scope of the present disclosure.

The TBS calculator unit 202 may calculate a transport block size using functions of a MAC scheduler 216, as per 3GPP Technical Specification 38.214, section 5.1.3.2. The TBS calculator unit 202 may obtain MAC Protocol Data Unit (PDU) size as an input from the MAC scheduler 216, and give the transport block size as an output for power consumption to the power estimation unit 212.

If a UE supports Channel Status Information (CSI) reporting, the UE reports CQI_format_indicator and CQI_index_value, which is 4-bit, and maps to 0-15 integer values. The CQI_index_value is given as input from the CQI estimator unit 204 to the MCS mapper unit 206. When CSI reporting is disabled, the UE may measure one or more signal parameters including, but not limited to, Reference Signal Received Power (RSRP), Reference Signal Received Quality (RSRQ), and Signal to Interference Noise Ratio (SINR). When a Synchronization Signal Block (SSB) block is transmitted during initial access, the one or more signal parameters may be shared by the UE to the gNB. The gNB estimates suitable CQI value for the UE, which may be shared to the MCS mapper unit 206.

The MCS mapper unit 206 may check a modulation order and code-rate in the CQI table 1 (if UE does not support 256-Quadrature Amplitude Modulation (QAM)). Alternatively, the MCS mapper unit 206 may use CQI table 2 and maps these values to the MCS index table and use the modulation scheme and code rate for a user associated with the UE. The MCS mapper unit 206 may provide the modulation scheme to the power estimation unit 212. It may be understood that the CQI table 1 and table 2 are as per 3GPP TS 38.214.

Referring to FIG. 2, the resource mapping unit 208 may assign resources required for a particular user for that time by taking the CQI and transport block size as inputs and providing resource assignment data as output to the PRB utilization unit 210 and the power estimation unit 212.

The PRB utilization unit 210 may pre-determine PRB utilization with the power consumed by the monitoring unit 104. The PRB utilization may be computed by:

PRB utilization=(Total number of used PRBs)/(Total number of PRBs)

PRB utilization may be determined for a fixed time (Transmission Time Interval (TTI), per slot duration). Further, the PRB utilization unit 210 may send the PRB utilization to the power estimation unit 212.

In an embodiment, the power estimation unit 212 includes two blocks, one for estimation of the power consumption per service per phase, and second for receiving a power consumption policy for that service from a core network 108 and monitoring real-time power consumption related parameters.

A base station allocates resources to different users availing a service by considering CQI and best possible MCS value. The below table 1 shows the MCS value and RB allocation of different users having different CQI values. In this table, the base station may classify users in three categories based on PRBs allocated: (1) users who occupy more number of PRBs are considered as HIGH (PRBs>100), (2) users who occupy lesser number of PRBs are considered as MID (50<PRBs<=100), and (3) users who occupy least number of PRBs are considered as LOW (PRBs<=50).

TABLE 1

| | | MCS | RB | UE |
|---|---|---|---|---|
| User | CQI | Value | allocated | classification |
| A | 2 | 1 | 342 | HIGH |
| B | 4 | 5 | 85 | MID |
| C | 27 | 11 | 57 | MID |
| D | 12 | 21 | 32 | LOW |
| E | 15 | 27 | 22 | LOW |

In some embodiments, a mobility manager at overall network level may use this information for optimal energy utilization.

In an exemplary embodiment, assume voice service is used by five users in the same base station. The base station schedules resources for different users according to their CQI values. User 1 and user 2 are scheduled in the first TTI and occupies 20 RBs and 40 RBs respectively. The other 3 users are scheduled in the second TTI where user 3 and user 4 occupy 15 RBs each and User 5 occupies 20 RBs.

Accordingly, PRB utilization per first TTI will be=60/273=0.219=21%. PRB utilization per second TTI will be=35/273=0.128=12%.

Therefore, the power estimation unit 212 may use the inputs from all other sub-units, as shown in FIG. 2 to estimate the power consumption value by the base station on a per service basis (for all phases of that service). In some embodiments, the power consumption related parameters may be stored at the database 214 for subsequent use.

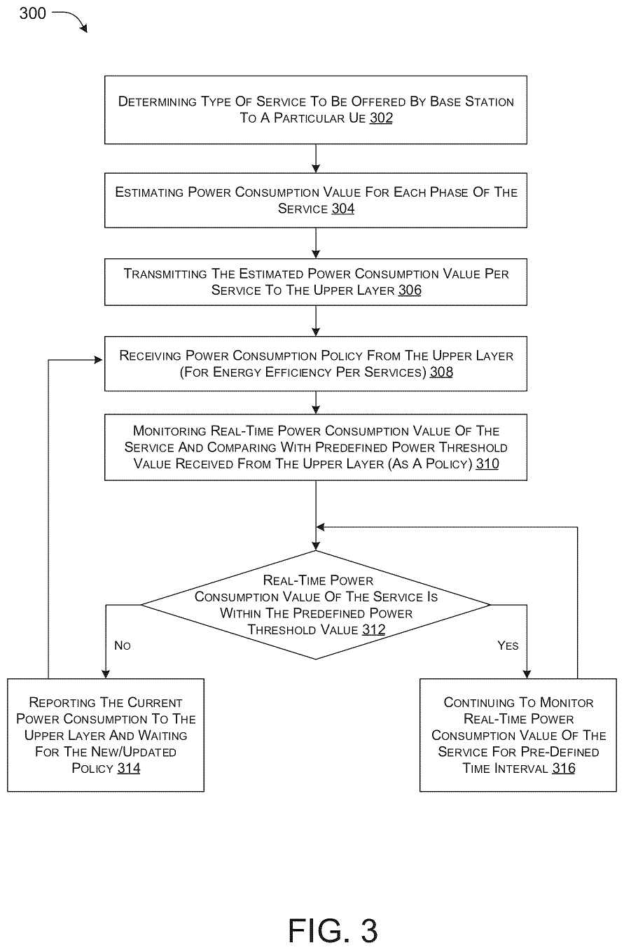

FIG. 3 illustrates a flow chart of an example method 300 for managing power consumption in an access network, in accordance with an embodiment of the present disclosure. It may be noted that the monitoring unit 104 (or base station or system) may perform the method 300.

Referring to FIG. 3, at block 302, the method 300 may include determining a type of a service to be offered by a base station to a particular UE. The type of the service may be given by 3GPP 23.501. For example, the type of the service may include, but not limited to, Voice over New Radio (VoNR) services, Internet services, real-time gaming services, Ultra Reliable Low Latency Communications (URLLC) services, and emergency services. In some embodiments, the method 300 may include receiving a request for the service corresponding to the UE in an access network, i.e., RAN. In some embodiments, the request may be received from the UE. In some other embodiments, the request may be received from a core network 108.

At block 304, the method 300 may include estimating a power consumption value for each phase of the service corresponding to the base station. For example, the power consumption value may be estimated for a setup phase, an active phase, and a terminate phase. The power consumption value may be based on, but not limited to, transport block size, and modulation coding scheme.

Further, at block 306, the method 300 may include transmitting the estimated power consumption value per service to the upper layers, for example, a core network 108. At block 308, the method 300 may include receiving a power consumption policy from the upper layer (i.e., the core network 108) for energy efficiency per service. In particular, the power consumption policy associated with the type of the service may be received from the core network 108. In some embodiments, the power consumption policy may include one or more pre-defined power threshold values associated with the type of the service. The one or more pre-defined power threshold values may include a minimum power threshold value required for the service, and a maximum power threshold value required for the service. It may be appreciated that there may be multiple levels of power threshold values in the power consumption policy required for the service. In some embodiments, the power consumption policy may be based on, but not limited to, the estimated power consumption value, and one or more resource parameters corresponding to PRB utilization. In some embodiments, the method 300 may include classifying the UE based on PRB utilization for a particular slot duration required for the service, and the power consumption may be based on the classification of the UE. In some embodiments, the method 300 may include comparing the estimated power consumption value with the one or more pre-defined power threshold values. It may be determined whether the estimated power consumption value is within the one or more pre-determined power threshold values. In response to determining that the estimated power consumption value is within the one or more pre-defined power threshold values, the method 300 may include transmitting a positive acknowledgement to the core network. In response to determining that the estimated power consumption value is not within the one or more pre-defined power threshold values, the method 300 may include transmitting a negative acknowledgement to the core network.

Referring to FIG. 3, at block 310, the method 300 may include monitoring a real-time power consumption value of the service corresponding to the base station. In some embodiments, the method 300 may include determining the real-time power consumption value of the service corresponding to the base station and monitoring the real-time power consumption value based on the power consumption policy. The real-time power consumption value may be based on, but not limited to, a power consumed by the base station in transitioning the UE from an idle phase to an active phase, a power consumed for a setup phase of the service, a power consumed for an active phase of the service, and a power consumed for the service in transition from the active phase to a terminate phase of the service. In some embodiments, the real-time power consumption value may be based on a power consumed for exchange of messages from the core network to the access network, and a power consumed in the access network.

In some embodiments, the real-time power consumption value may be compared with the one or more pre-defined power threshold values. At block 312, the method 300 may include determining whether the real-time power consumption value is within the one or more pre-defined power threshold values. If the real-time power consumption value is within the one or more pre-defined power threshold values, at block 316, the method 300 may include continuing to monitor the real-time power consumption value for the service for a pre-defined time interval. If the real-time power consumption value is not within the one or more pre-defined power threshold values, at block 314, the method 300 may include transmitting the current real-time power consumption value to the upper layer (i.e., core network). In some embodiments, the power consumption policy may be stored at the database 214 and the real-time power consumption value may be monitored until the service is terminated. After the service is terminated, the updated real-time power consumption policy may be transmitted to the core network. The core network, based on the updated real-time power consumption policy, may send an updated power consumption policy to the base station. In some embodiments, the real-time power consumption value of each phase of the service corresponding to the base station and the UE for different RB allocations and different time stamps is stored in the database 214.

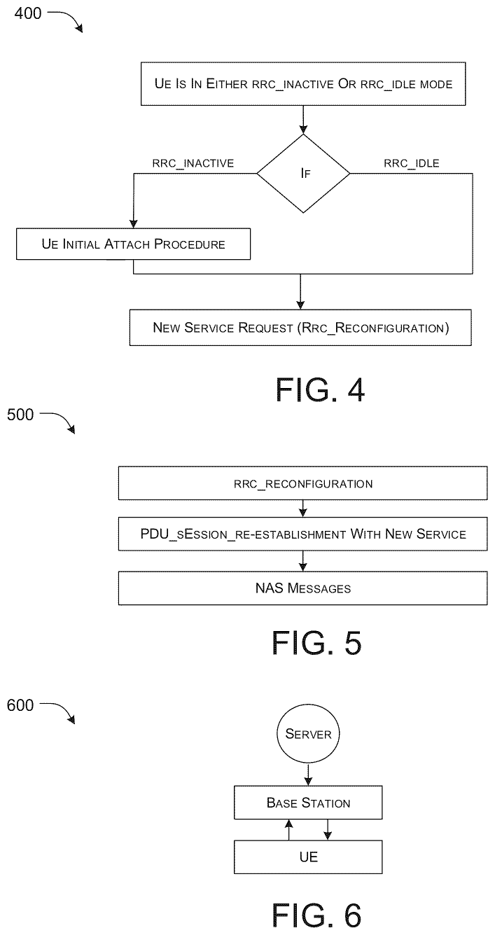

FIGS. 4-6 illustrate exemplary flow diagrams (400, 500, 600) for different phases of a service, in accordance with embodiments of the present disclosure.

Referring to FIG. 4, the flow diagram 400 depicts steps corresponding to a transition of a UE from an inactive to a setup phase. In the inactive phase, the UE may either be switched off or in sleep mode. For example, in this phase, the UE is in either RRC_INACTIVE or RRC_IDLE state, as shown in FIG. 4. If the UE is in RRC_INACTIVE state, then the UE has to connect to the base station using initial UE attach procedure. If the UE is in RRC_IDLE, the UE may directly raise new service request.

Referring to FIG. 5, the flow diagram 500 depicts steps corresponding to a setup phase of a service. In the setup phase, the UE requests for a new service using RRC_reconfiguration message. Following the RRC_reconfiguration message, a new Data Radio Bearer (DRB) is setup for the new service in the PDU session established between UE and base station. Corresponding Non-Access Stratum (NAS) messages are exchanged.

Referring to FIG. 6, the flow diagram 600 depicts steps corresponding to an active phase of a service. In the active phase, the UE is connected to the new service and is using the new service. In this phase, application layer data is transferred in both uplink and downlink directions.

In the terminate phase, the service required by the UE is completed and the base station terminates that particular service to the UE. Same RRC_reconfiguration message is exchanged between UE and the base station, as depicted in FIG. 5. Following the RRC_reconfiguration message, the bearer is removed from this service in the PDU session established between UE and the base station. Further, corresponding NAS messages are exchanged.

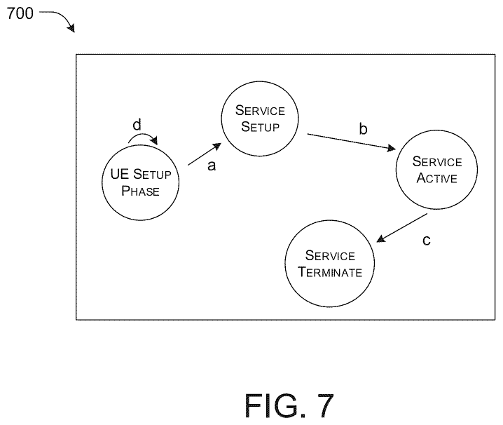

FIG. 7 illustrates a transition diagram 700 for lifecycle of a service corresponding to a base station and a UE, in accordance with an embodiment of the present disclosure.

In some embodiments, total power consumed by a service ‘x’ at ith instance is as follows:

$$Power ( x , i ) = Power {( x , i )}_{a} + Power {( x , i )}_{b} + Power {( x , i )}_{c} + Power {( x , i )}_{d}$$

Power(x, i)_{d}—Power consumed the by base station in transitioning UE from inactive or idle to active state;
Power(x, i)ₐ—Power consumed for the service setup phase;
Power(x, i)_{b}—Power consumed for the service in active phase; and
Power(x, i)_{c}—Power consumed for the service in transition from active to terminate phase.

As shown in FIG. 7, UE has to be in the active state to avail a service.

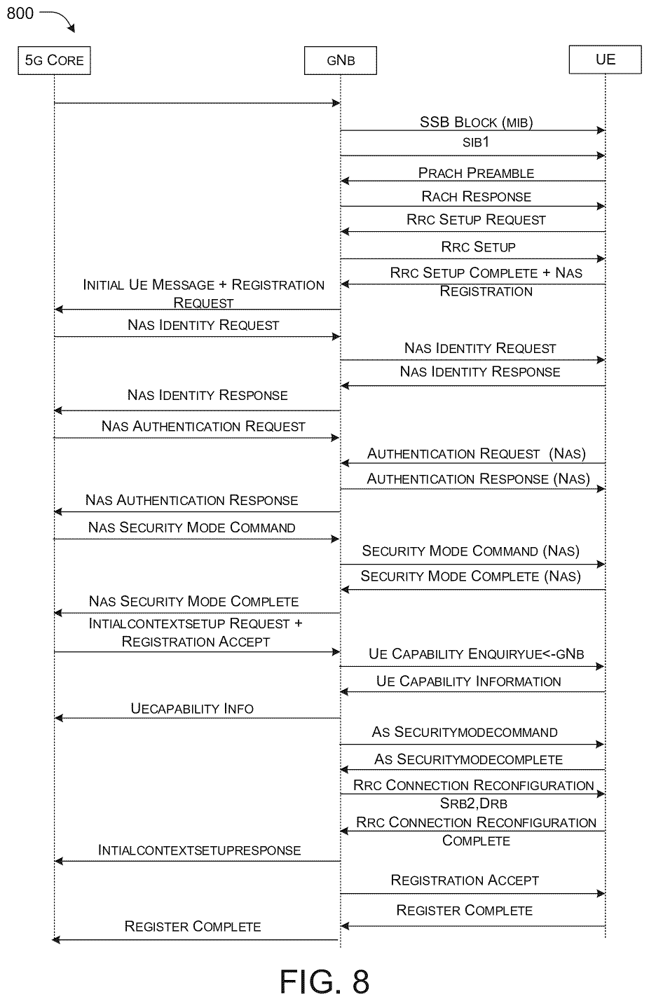

FIG. 8 illustrates an exemplary flow diagram 800 of exchange of control messages in UE initial attach phase, in accordance with an embodiment of the present disclosure.

In some embodiments, maximum power consumed in the initial UE attach procedure is in the SSB block and System Information Block (SIB) 1. Base station transmits a signal, i.e. synchronization signal to UE for synchronization with the base station. These signals are transmitted at a regular interval of time (e.g., 20 ms) which is pre-defined. When a UE is switched on after some time of inactivity, for the initial connection to the base station, UE uses these signals for the selection of the base station. All the signals for the synchronization are transmitted as a single block, called SSB or Physical Broadcast Channel (PBCH) block.

One SSB is transmitted in four Orthogonal Frequency Division Multiplexing (OFDM) symbols over 240 resource elements per each symbol. Primary Synchronization Signal (PSS) and Secondary Synchronization Signal (SSS) occupies 127 Resource Elements (Res) starting from 57 to 183 on 1 and 3 OFDM symbol. PBCH occupies 2, 4 OFDM symbols and 8 RBs in 3 OFDM symbol. Total number of REs required for one SSB block is 960. It may be understood that the SSB block structure is as per 3GPP TS 38.211, clause 7.4.3.

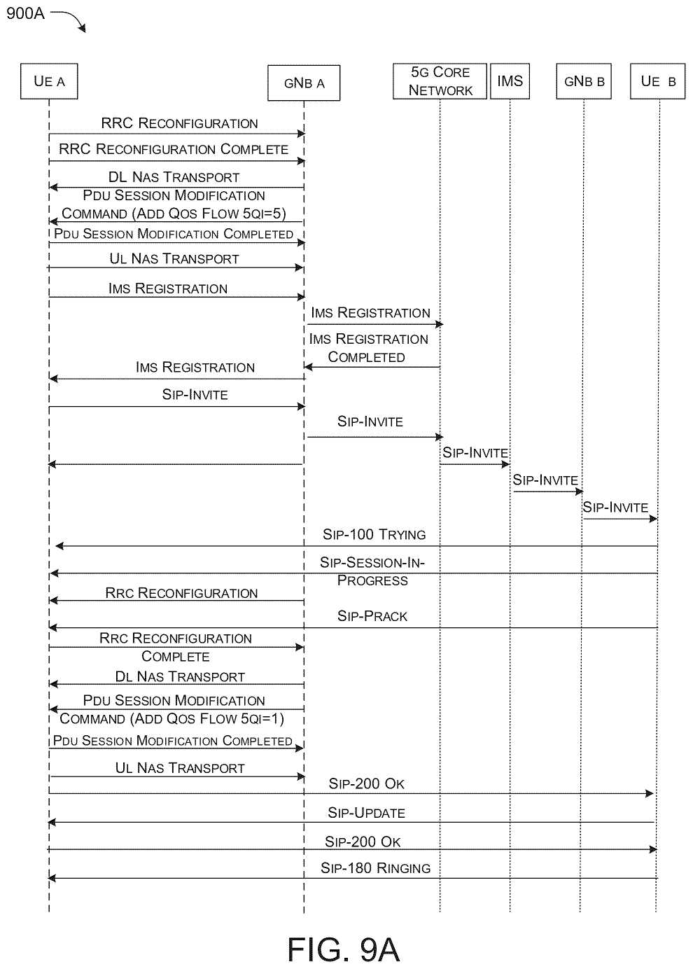

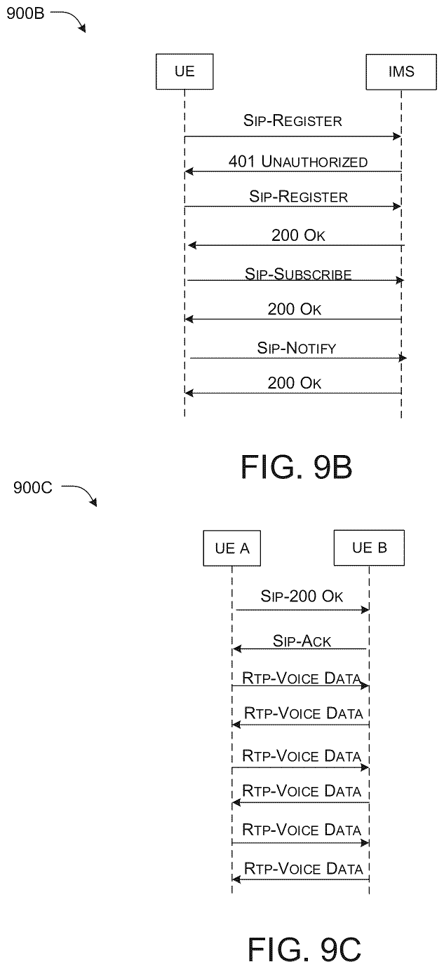

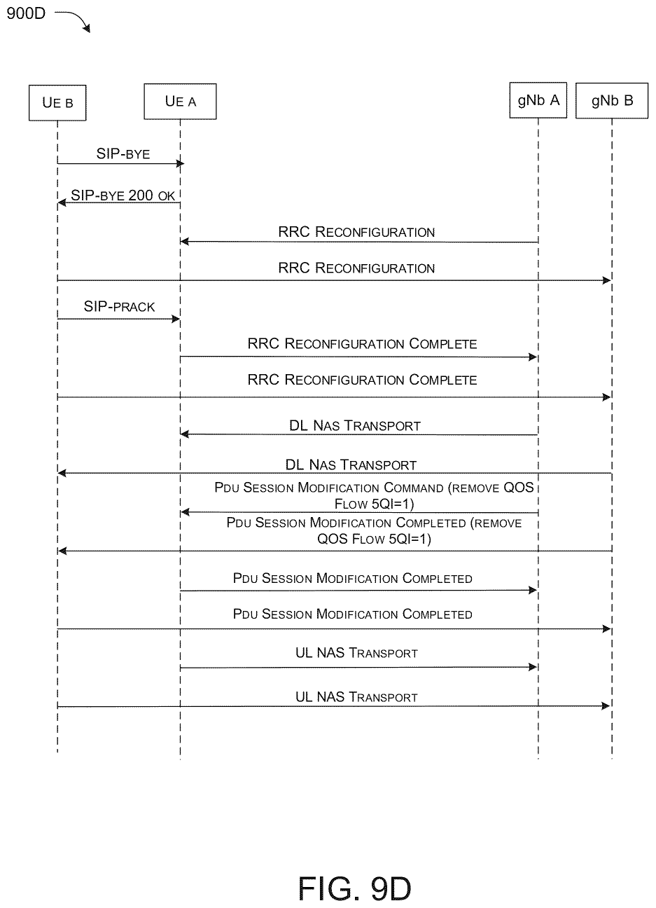

Assuming that UE (e.g., UE A) starts a voice service to another UE (e.g., UE B). Power consumption for the voice service is explained below in detail. It may be appreciated that the power consumption may be estimated in a similar manner for all other type of services. FIG. 9A illustrates an exemplary flow diagram 900A for exchange of control messages for a voice call setup between a first UE (e.g., UE A) and a second UE (e.g., UE B), in accordance with embodiments of the present disclosure. FIG. 9B illustrates an exemplary flow diagram 900B for exchange of control messages for UE registration, in accordance with embodiments of the present disclosure. FIG. 9C illustrates an exemplary flow diagram 900C for exchange of control messages for a voice service in active phase, in accordance with embodiments of the present disclosure. FIG. 9D illustrates an exemplary flow diagram 900D for exchange of control messages for a voice service in terminate phase, in accordance with embodiments of the present disclosure.

In all the phases in a voice service, as shown in FIGS. 9A-9D, power consumed in initial attach phase, setup phase, and terminate phase may be constant. i.e., when a same service is started, again the control messages for the setup phase and the terminate phase may be the same. The power consumption difference may come in the active phase. In some embodiments, the monitoring unit 104 may estimate total data that is transferred from application layer to UE via base station. IP multi-media subsystem (IMS) is the application layer for voice data and Short Message Service (SMS) in 5G. In IMS, Media Resource Function (MRF) converts analog voice to digital voice signal using codec. One digital speech sample is made up of the bits produced for a 10 ms analog voice stream. The codec determines the size of the digital voice sample. Assuming G.729 Codec is used for a voice call which has a bit rate of 8 kbps.

$$One digital voice sample = 8000 b p s * \frac{10}{1000} = 80 bits per 10 ms = 10 Bytes per 10 ms$$

Assuming G.711 Codec is used for a voice call which has a bit rate of 64 kbps.

$$One digital voice sample = 64000 b p s * \frac{10}{1000} = 640 bits per 10 ms = 80 bytes per 10 ms$$

One digital voice data sample size depends on the codec used and varies according. In some embodiments, the sample size may be calculated as follows:

$$one digital voice sample = bitrate * \frac{10}{1000}$$

10 ms of bits in analog signal constitute one digital sample.

Further, total information encapsulated for a pre-defined period in each packet is referred to as a packetization period. If the packetization period is 20 ms, then it is equal to the 2 digital voice samples. Therefore, total voice data for that packet is 80 Bytes (if G.711 is used).

$$Voice data per packet = \frac{packetization period}{10 ms} * size of digital sample$$

After packetization is done, the packet is added with a Real time Transport Protocol (RTP) header of 12 Bytes. After that, the next layer in IMS is IP network with adds a User Datagram Protocol (UDP) and IP header to the packet and sends it to the corresponding User Plane Function (UPF).

$$Total packet size = 160 Bytes + 12 Bytes = 172 Bytes$$

Total number of bytes required for UDP, IP headers for a packet is called IP overhead. UDP overhead is 8 Bytes. IP overhead is 40 Bytes.

Further, the packet structure from the application layer to the next layer in the protocol stack is as follows:

$${Applicationlayer}_{PDU} = ( IP + UDP + RTP ) header + payload$$

$$Application layer PDU = 4 Bytes + 160 Bytes = 164 Bytes ( using G \text{.711} codec )$$

After that, the packet is sent to the IP network, which sends the packet to the UPF, which is first point of entry to 5G core network. UPF maps these packets to associated Quality of Service (QOS) flow and identifies the PDU session it belongs to. UPF uses GPRS Tunnelling Protocol (GTP)-U tunnel to send these packets to the base station (gNB). gNB-CU (e.g., 102-1) receives the Layer 3 (L3) PDU at the other end of GTP tunnel and using GTP-U header information, the gNB-CU identifies the PDU session and QOS flow associated with it. Then, the packet is sent to Service Data Adaptation Protocol (SDAP) Layer for processing. SDAP layer maps these packets to different DRBs according to their QOS identifier. Therefore, L3 layer PDU becomes SDAP Service Data Unit (SDU). SDAP Layer forwards the packet to the Packet Data Convergence Protocol (PDCP) layer. After this layer, the packet is forwarded to corresponding DU (e.g., 102-2) using f1-interface using GTP-U tunnels, but here GTP-U tunnels are mapped per DRB. So, header is added to these packets, i.e., New Radio (NR) RAN container. The corresponding gNB-DU receives the packet at the other end and sends these SDUs to RLC layer for processing. The RLC has three different modes. Voice packets are sent over Dedicated Traffic Channel (DTCH) that sends only one user traffic. The data sent on DTCH may use unacknowledged mode (UM) transmission. In unacknowledged mode, the transmission only header of RLC is added to the RLC SDU. If RLC gets a downlink grant for the transport block size from the MAC layer, then RLC may segment the information and send to the MAC layer with a size of transport block. MAC adds header to every MAC SDU and then concatenates these SDUs to get the transport block size, and then adds Cyclic Redundancy Check (CRC) to the whole transport block size. CRC for transport block is 3 Bytes. As an example, Table 2 below gives different header sizes in different layers, as defined in respective 3GPP standards.

TABLE 2

| Headers | Header size (Bytes) | 3GPP standard |
|---|---|---|
| SDAP | 1 | 37.324 |
| PDCP | 3 | 38.323 |
| RLC | 3 | 38.322 |
| MAC | 1 | 38.321 |

Total packet size of MAC PDU = transport block size + 3 Bytes.
This is the total data transferred to the MAC layer.

As explained for the identification of packetization period, size of the IMS voice data for one packet may be decided by the packetization period used for that voice call.

In accordance with embodiments of the present disclosure, a service provider may classify customers into three user subscription levels (e.g., Premium, Normal, Best effort). Network allows high priority and maximum resources for the Premium class customers. Network allows medium priority and resources for the Normal class customers. Best effort packet rate for availing the service is provided to the customers, which are under Best effort class category. According to the customer type, the base station may send maximum packet size related parameters to the upper layer for a particular service (e.g., voice service). According to the given update, mobility manager updates the IMS server for configuring packetization period. In this way, the application server configures packetization period by taking inputs from the network side and shares the information to the base station. In particular, the base station or the monitoring unit 104 may determine a user subscription level associated with the UE, and configure the packetization period for the UE based on the user subscription level.

In accordance with embodiments of the present disclosure, the monitoring unit 104 may estimate the total power consumption value corresponding to the base station in active phase as follows:

$${Power}_{total} = {Power}_{CN - AN} + {Power}_{AN}$$

where, Power_{CN-AN}—Power consumed from Core Network to Access Network; and Power_{AN}—Power consumed in the Access Network.

In some embodiments, the monitoring unit 104 may estimate the power consumption value for exchange of messages between the core network and the access network. As an example, information may be transferred from the core network to the access network using an Ethernet cable.

According to the specification of the Ethernet cable, assuming an X GB interface that takes Y Watts of power.
Total power consumed per bit per second is (Y/X) watt/bit.
Power consumed for ‘n’ bits transferred is n*(Y/X) watt.

As another example, assuming there is an Ethernet cable with 1 GB/second and power consumed is 20 W.

Power required to transfer 680 bytes=(20*10\hat{ }−9)*680=0.0136 mW.

Power computation may be applied to all the interfaces where Ethernet cable is used for communication. In some embodiments, for estimating the power consumption in the access network, MAC scheduler functions such as transport block size calculation, CQI to MCS mapper, and resource allocation may be considered. MAC comprises the information corresponding to number of information bits (N_{info}) to be scheduled, which is MAC SDU size. The transport block size may be calculated based on 3GPP TS 38.214, table 5.1.3.2-2. As an example,
N_{info}=1432 bits (MAC SDU size)
N_{info}¹=1424 bits
TBS=1480 bits
Total MAC PDU size will be 1480+16 (CRC)=1496 bits.

In some embodiments, MAC scheduler receives the CQI index value from CSI reporting, as shown in FIG. 2. The scheduler maps the index to the CQI tables, as defined in 3GPP TS 38.214, after selecting the CQI table and corresponding modulation scheme and code rate. The MAC scheduler selects appropriate modulation scheme.

After determination of transport block size and modulation code scheme, the MAC scheduler allocates resources. As an example,
MAC SDU size for a voice call is 1432 bits.
TBS size after calculation is 1480 bits.
MAC PDU size is 1496 bits.

Assuming CQI value is 7 and UE supports 64-QAM. The MAC scheduler uses CQI table 1 and maps it with MCS table 1. MCS index=11, Qₘ=4, Code-rate=378/1024.

$$No of REs = ( MAC PDU Size * ( \frac{1}{coderate} ) ) / {Q}_{m}$$

Here, Qₘ—Modulation order; and
Code-rate—Code-rate from MCS table.

$$Number of REs = ( 1496 * ( 1 \; 024 / 378 ) ) / 4 = 1024 Res . = 85 PRBs$$

Total initial power required for the system (e.g., RU or DU) when no load or no PRBs are allocated is p0. Table 3 below depicts minimum power dynamic range for different Subcarrier Spacing (SCS), which is defined in 3GPP 38.104.

TABLE 3

| | |
|---|---|
| BS channel | Total power dynamic range |

| bandwidth (MHz) | 15 kHz SCS | 30 kHz SCS | 60 kHz SCS |
|---|---|---|---|
| 5 | 13.9 | 10.4 | N/A |
| 10 | 17.1 | 13.8 | 10.4 |
| 15 | 18.9 | 15.7 | 12.5 |
| 20 | 20.2 | 17 | 13.8 |
| 25 | 21.2 | 18.1 | 14.9 |
| 30 | 22 | 18.9 | 15.7 |
| 40 | 23.3 | 20.2 | 17 |
| 50 | 24.3 | 21.2 | 18.1 |
| 60 | N/A | 22 | 18.9 |
| 70 | N/A | 22.7 | 19.6 |
| 80 | N/A | 23.3 | 20.2 |
| 90 | N/A | 23.8 | 20.8 |
| 100 | N/A | 24.3 | 21.3 |

As an example, base station is using SCS=15 KHz and below defined channel bandwidths, then lower limit of Total Power Dynamic Range (TPDR) is as follows:
channel bandwidth=20 MHz
   Assuming, maximum power of a base station is 1 W.

$$Total number of PRBs = 20 / 15 = 111 PRBs$$

$$Power per RB is = 1 / 1 \; 11$$

$$Lower limit of T P D R = 10 log ( 1 / 111 ) = 20.4 dB$$

b.) channel bandwidth 30 MHz
   Assuming, maximum power of a base station is 1 W.

$$Total number of PRBs = 30 / 15 = 200 PRBs$$

$$Power per RB is = 1 / 200$$

$$Lower limit of T P D R = 10 log ( 1 / 200 ) = 23.4 dB$$

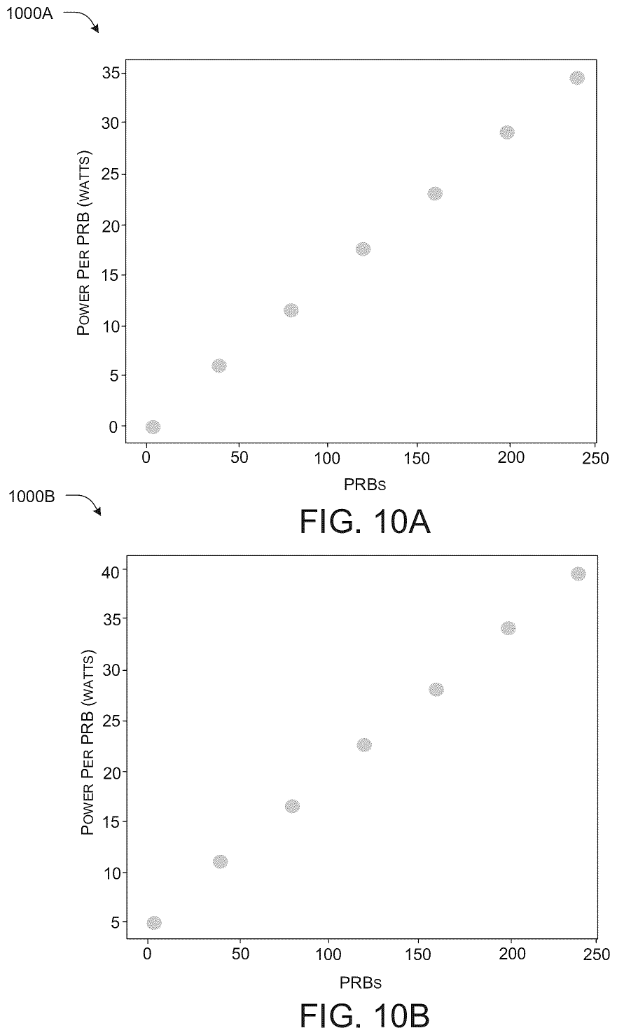

FIG. 10A shows an exemplary representation 1000A of power distribution by increasing PRBs, in accordance with embodiments of the present disclosure. As shown in 10A, power is linearly varying (approximately) according to the PRBs. Here, the maximum value is 24.3 dB that is used when full 273 PRBs are occupied. So, total power consumed is linearly distributing across all PRBs uniformly.

FIG. 10B shows an exemplary representation 1000B of power distribution in case of initial power, in accordance with embodiments of the present disclosure.

In ideal case, when zero PRBs are allocated, the power distribution is zero. However, in real scenario, power consumed when zero PRBs are allocated is p0. The value of initial power (p0) is shared with the monitoring unit 104 for power computation. p0 depends on hardware aspects of the base station such as number of active Radio Frequency (RF) chains, etc. The base station also requires Direct Current (DC) power for maintaining power amplifiers and other hardware components in the active state. Hence. the earlier graph is shifted slightly above at p0 (for zero PRBs). Assuming total initial power required p0=5 W, then the graph shifts to account for the initial power.

In some embodiments, the total estimated power consumption value for communicating n number of PRBs for a particular service is given as:
Total output power when no PRBs are allocated is p0.
Total output power of a base station when all PRBs are allocated is X Watts.
Total power consumed for Y PRBs is

$$p 0 + 10 * log ( \frac{X}{273} * Y )$$

Assuming, total output power when no PRBs are allocated is 10 W=30+10 log (10)=40 dB
Maximum output power of a RU is 40 W.
Power required for 100 PRBs=40 dB+10 log (40*100/273)=51.65 dB

Therefore, the monitoring unit 104 may estimate the power consumption value for a voice service in downlink, as explained above. Same process may be applied to uplink. In uplink, size of data to be transmitted is given to the MAC scheduler in Buffer Status Report (BSR). By calculating Received Signal Strength (RSS), and Signal to Noise Ratio (SNR) from UE to the base station, the MAC scheduler may measure uplink_CQI value. After calculation of CQI value and MAC PDU size, similar steps may be used to estimate the power consumption value.

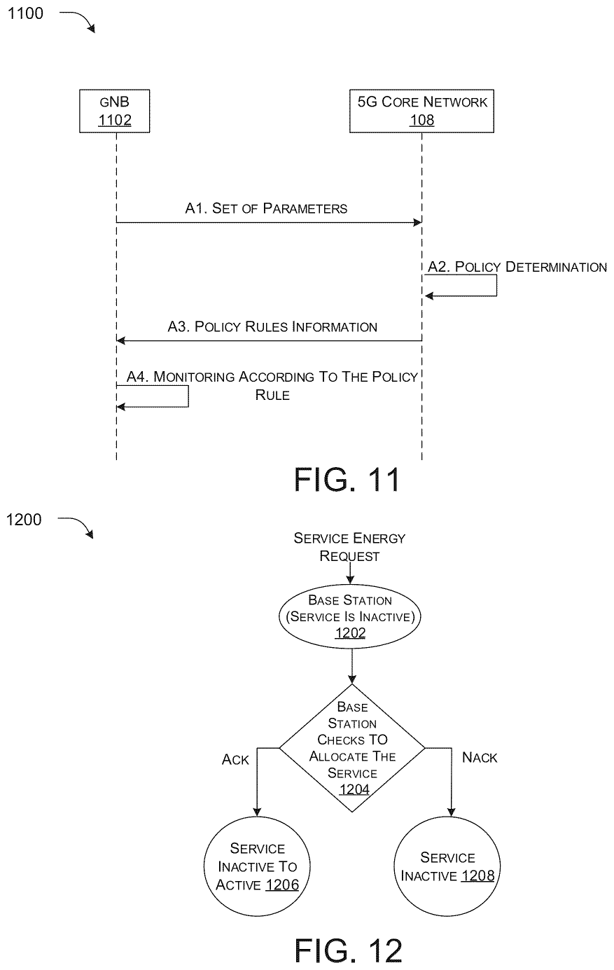

FIG. 11 illustrates an exemplary flow diagram 1100 for exchange of messages between a base station and a core network, in accordance with embodiments of the present disclosure.

Referring to FIG. 11, in some embodiments, at step A1, a set of parameters may be transmitted by the base station 1102 to the core network 1104. The set of parameters may include, but not limited to, total energy/power required for each service, total energy required in setup phase for each service, total energy required in active phase for each service, total energy required in terminate phase for each service, PRB utilization, category of base station 1102 (e.g., wide area, small cell, etc.), rated power of base station 1102, and power amplifier efficiency of base station 1102.

At step A2, a power consumption policy may be determined for every service by calculating the minimum and maximum power (or one or more pre-defined power threshold values) required for that service, i.e., minimum energy required for a service when highest CQI is used, and energy estimation is done, and maximum energy required for a service when least CQI is used, and energy estimation is done.

As an example, assuming, for a voice call at an instant in active phase,
TBS size is 1480 bits.
MAC PDU size is 1496 bits.
Policy determination—
Least CQI value is 1 (MCS value is 0)
No of PRBs for least CQI value=(1496*(120/1024))/2=531 PRBs
Total power (p0=X w)=X+77.8 watts; wherein X is the power consumed by the base station when no PRBs are allocated. Further, X is measured in Watts.
Highest CQI value is 15 (MCS value is 28)
No of PRBs for maximum CQI value=(1496*(948/1024))/6=22 PRBs

$$Total power ( p 0 = X w ) = X + 3.22 watts$$

Power range when voice service is activated should be in between (X+77.8, X+3.22) watts.

Referring to FIG. 11, at step A3, the power consumption policy including policy rules information may be transmitted from the core network 1104 to the base station 1102. Accordingly, at step A4, the base station 1102 (particularly, the monitoring unit 104) may monitor real-time power consumption value for the service.

FIG. 12 illustrates an exemplary flow diagram 1200 for exchanges of messages between a base station and a core network once the base station receives power consumption policy, in accordance with embodiments of the present disclosure.

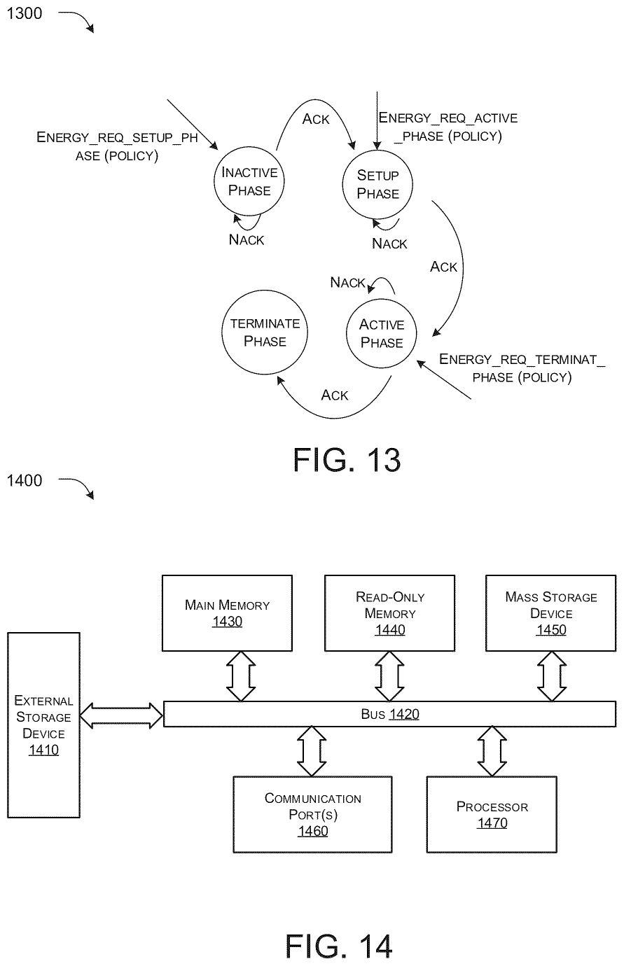

In accordance with embodiments of the present disclosure, at step 1202, the base station receives the power consumption policy for a given phase of the service including the associated energy related parameters (as policy). After receiving the policy parameters, at step 1204, the base station performs analytics based on historical power related parameters and the estimated power consumption value to identify whether the base station can accommodate the service within the permissible energy limits. If the base station identifies that the base station can accommodate the service within the permissible energy limits, at step 1206, the base station acknowledges (ACK) a service energy request. If not, at step 1208, the base station transmits a negative acknowledgement (NACK) to the upper layer (i.e., core network). The base station then transits to the acknowledged service phase or remains in the same service phase (in case of NACK). A similar analysis may be performed during each service phase transitioning. FIG. 13 illustrates an exemplary transition diagram 1300 for a service, in accordance with embodiments of the present disclosure.

As discussed herein, assuming that the base station has accepted the service energy request from the core network, during each of the service phases, the monitoring unit 104 may determine and/or monitor real-time power consumption value. The monitoring unit 104 may compare the real-time power consumption value with the power consumption policy, i.e. the one or more pre-defined power threshold values. If the real-time power consumption value corresponding to a phase of the service is not within the one or more pre-defined power threshold values, the monitoring unit 104 may send the current power consumption value to the core network. Alternatively, if the real-time power consumption value is within the one or more pre-defined power threshold values, the monitoring unit 104 may continue to monitor the real-time power consumption value for a pre-determined time interval until the service is terminated.

In some embodiments, the monitoring unit 104 may store power consumption patterns for each service request in a local repository, for example, the database 214. The base station utilizes these stored power consumption related parameters to analyse the power consumption policy received from the core network. Additionally, the base station may report the same to the core network for future energy optimization related policy determination.

Table 4 below shows the information stored in the database 214 along with other UE and channel related parameters.

TABLE 4

| | RB | Time Stamps | | | | |
|---|---|---|---|---|---|---|
| Service Phase | allocation | t0 | t1 | t2 | . . . | tn |
| SETUP | 10 | P₁₀ | P₁₁ | P₁₂ | . . . | P₁ₙ |
| | 20 | P²⁰ | P₂₁ | P₂₂ | . . . | P₂ₙ |
| | * | * | * | * | * | * |
| | * | * | * | * | * | * |
| | * | * | * | * | * | * |
| | 100 | Pₘ₀ | Pₘ₁ | Pₘ₂ | . . . | Pₘₙ |
| ACTIVE | 10 | P₁₀ | P₁₁ | P₁₂ | . . . | P₁ₙ |
| | 20 | P²⁰ | P₂₁ | P₂₂ | . . . | P₂ₙ |
| | * | * | * | * | * | * |
| | * | * | * | * | * | * |
| | * | * | * | * | * | * |
| | 100 | Pₘ₀ | Pₘ₁ | Pₘ₂ | . . . | Pₘₙ |
| TERMINATE | 10 | P₁₀ | P₁₁ | P₁₂ | . . . | P₁ₙ |
| | 20 | P²⁰ | P₂₁ | P₂₂ | . . . | P₂ₙ |
| | * | * | * | * | * | * |
| | * | * | * | * | * | * |
| | * | * | * | * | * | * |
| | 100 | Pₘ₀ | Pₘ₁ | Pₘ₂ | . . . | Pₘₙ |

Therefore, the present disclosure facilitates energy optimization during each stage or phase of a given service.

The methods and techniques described here may be implemented in digital electronic circuitry, field programmable gate array (FPGA), or with a programmable processor (for example, a special-purpose processor or a general-purpose processor such as a computer) firmware, software, or in combinations of them. Apparatus embodying these techniques may include appropriate input and output devices, FPGA, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system, explained in detail with reference to FIG. 14, including at least one programmable processor coupled to receive data and instructions from, and to transmit data and instructions to, a data storage system, at least one input device, and at least one output device. Generally, a processor will receive instructions and data from a read-only memory and/or a random-access memory. Storage devices suitable for tangibly embodying computer program instructions and data include all forms of non-volatile memory, including by way of example semiconductor memory devices, such as erasable programmable read-only memory (EPROM), and flash memory devices; magnetic disks such as internal hard disks and removable disks; and magneto-optical disks. Any of the foregoing may be supplemented by, or incorporated in, specially designed application-specific integrated circuits (ASICs).

In particular, FIG. 14 illustrates an exemplary computer system 1400 in which or with which embodiments of the present disclosure may be utilized. The computer system 1400 may be implemented as or within the base station described in accordance with embodiments of the present disclosure.

As depicted in FIG. 14, the computer system 1400 may include an external storage device 1410, a bus 1420, a main memory 1430, a read-only memory 1440, a mass storage device 1450, communication port(s) 1460, and a processor 1470. A person skilled in the art will appreciate that the computer system 1400 may include more than one processor 1470 and communication ports 1460. The processor 1470 may include various modules associated with embodiments of the present disclosure. The communication port(s) 1460 may be any of an RS-232 port for use with a modem-based dialup connection, a 10/100 Ethernet port, a Gigabit or 10 Gigabit port using copper or fiber, a serial port, a parallel port, or other existing or future ports. The communication port(s) 1460 may be chosen depending on a network, such a Local Area Network (LAN), Wide Area Network (WAN), or any network to which the computer system 1400 connects.

In an embodiment, the main memory 1430 may be Random Access Memory (RAM), or any other dynamic storage device commonly known in the art. The read-only memory 1440 may be any static storage device(s) e.g., but not limited to, a Programmable Read Only Memory (PROM) chips for storing static information e.g., start-up or basic input output system (BIOS) instructions for the processor 1470. The mass storage device 1450 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus 1420 communicatively couples the processor 1470 with the other memory, storage, and communication blocks. The bus 1420 may be, e.g., a Peripheral Component Interconnect (PCI)/PCI Extended (PCI-X) bus, Small Computer System Interface (SCSI), universal serial bus (USB), or the like, for connecting expansion cards, drives, and other subsystems as well as other buses, such a front side bus (FSB), which connects the processor 1470 to the computer system 1400.

In another embodiment, operator and administrative interfaces, e.g., a display, keyboard, and a cursor control device, may also be coupled to the bus 1420 to support direct operator interaction with the computer system 1400. Other operator and administrative interfaces may be provided through network connections connected through the communication port(s) 1460. Components described above are meant only to exemplify various possibilities. In no way should the aforementioned exemplary computer system 1400 limit the scope of the present disclosure.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Present Disclosure

The present disclosure provides an efficient solution for service-based optimization of base station based on fine tuning resource utilization as a power saving strategy.

The present disclosure facilitates recommending a power saving mechanism to be adopted during different phases of a service.

The present disclosure provides an adaptive power saving mechanism for the base station which considers power consumption during each phase of the service with effective resource utilization.

We claim:

1. A method for managing power consumption in an access network (102), comprising:
receiving, by a processor associated with a base station (1102), a request for a service corresponding to a user equipment in the access network (102);
determining, by the processor, a type of the service based on the request;
estimating, by the processor, a power consumption value for each phase of the service corresponding to the base station (1102);
transmitting, by the processor, at least the estimated power consumption value to a core network (108);
receiving, by the processor, a power consumption policy associated with the type of the service from the core network (108);
determining, by the processor, a real-time power consumption value of the service corresponding to the base station (1102); and
monitoring, by the processor, the real-time power consumption value corresponding to the base station (1102) based on the power consumption policy.

2. The method as claimed in claim 1, wherein the power consumption policy comprises one or more pre-defined power threshold values associated with the type of the service.

3. The method as claimed in claim 2, wherein monitoring, by the processor, the real-time power consumption value comprises:
comparing, by the processor, the real-time power consumption value of the service with the one or more pre-defined power threshold values; and
determining, by the processor, whether the real-time power consumption value is within the one or more pre-defined power threshold values.

4. The method as claimed in claim 3, wherein, in response to a determination that the real-time power consumption value is within the one or more pre-defined power threshold values, the method comprises:
continuing, by the processor, to monitor the real-time power consumption for a pre-defined time interval.

5. The method as claimed in claim 3, wherein, in response to a determination that the real-time power consumption value is not within the one or more pre-defined power threshold values, the method comprises:
transmitting, by the processor, the real-time power consumption value of the service to the core network (108).

6. The method as claimed in claim 2, wherein, in response to receiving, by the processor, the power consumption policy, the method comprises:
comparing, by the processor, the estimated power consumption value with the one or more pre-defined power threshold values; and
determining, by the processor, whether the estimated power consumption value is within the one or more pre-defined power threshold values.

7. The method as claimed in claim 6, wherein, in response to a determination that the estimated power consumption value is within the one or more pre-defined power threshold values, the method comprises transmitting, by the processor, a positive acknowledgement to the core network (108), and in response to a determination that the estimated power consumption value is not within the one or more-predefined power threshold values, the method comprises transmitting, by the processor, a negative acknowledgement to the core network (108).

8. The method as claimed in claim 1, wherein the real-time power consumption value is based on at least one of: a power consumed by the base station (1102) in transitioning the user equipment from an idle phase to an active phase, a power consumed for a setup phase of the service, a power consumed for an active phase of the service, and a power consumed for the service in transition from the active phase to a terminate phase of the service.

9. The method as claimed in claim 1, wherein the real-time power consumption value is based on at least one of: a power consumed for exchange of messages from the core network (108) to the access network (102), and a power consumed in the access network (102).

10. The method as claimed in claim 1, comprising storing, by the processor, the real-time power consumption value of said each phase of the service corresponding to the base station (1102) and the user equipment for different Resource Block (RB) allocations and different time stamps in a database (214) associated with the base station (1102).

11. The method as claimed in claim 1, wherein the estimated power consumption value is based on transport block size and modulation coding scheme.

12. The method as claimed in claim 11, comprising classifying, by the processor, the user equipment based on Physical Resource Block (PRB) utilization for a particular slot duration required for the service, wherein the estimated power consumption value is based on the classification of the user equipment.

13. The method as claimed in claim 1, wherein the power consumption policy is based at least on one of: the estimated power consumption value including total power required in setup phase for the service, total power required in active phase for the service, total power required in terminate phase for the service, Physical Resource Block (PRB) utilization, category of the base station (1102), rated power of the base station (1102), and power amplifier efficiency of the base station (1102).

14. The method as claimed in claim 1, wherein the type of the service is a voice service, and wherein the method comprises:
determining, by the processor, a user subscription level associated with the user equipment; and
configuring, by the processor, a packetization period for the user equipment based on the user subscription level.

15. A base station (1102) for managing power consumption in an access network (102), comprising:
a processor; and
a memory operatively coupled with the processor, wherein the memory comprises instructions which, when executed, cause the processor to:
receive a request for a service corresponding to a user equipment in the access network (102);
determine a type of the service based on the request;
estimate a power consumption value for each phase of the service corresponding to the base station (1102);
transmit at least the power consumption value to a core network (108);
receive a power consumption policy associated with the type of the service from the core network (108);
determine a real-time power consumption value of the service corresponding to the base station (1102); and
monitor the real-time power consumption value corresponding to the base station (1102) based on the power consumption policy.
